(19) United States
(12) Patent Application Publication
(10) Pub. No.: US 2025/0163225 A1
(43) Pub. Date: May 22, 2025

(54) POLYALKYLENE OXIDE-RUBBER BLOCK COPOLYMERS AND METHODS FOR MAKING THE SAME

(71) Applicant: The Goodyear Tire & Rubber Company, Akron, OH (US)

(72) Inventor: Gyusaang Youn, Copley, OH (US)

(21) Appl. No.: 18/511,541

(22) Filed: Nov. 16, 2023

(51) Int. Cl. C08G 81/02; B60C 1/00; C08K 3/04; C08K 3/36

(52) U.S. Cl. CPC C08G 81/025; B60C 1/0016; C08K 3/04; C08K 3/36

(57) ABSTRACT

In one aspect, the disclosure relates to a block copolymer comprising a first block derived from an alkene and a second block derived from an epoxide. In another aspect, the block copolymer has the structure

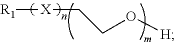

wherein X is selected from:

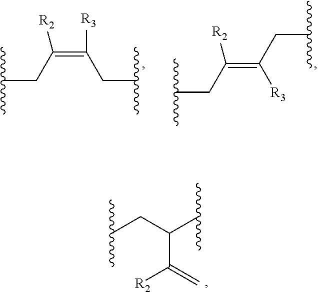

or any combination thereof;
wherein R₁ is selected from H or a C1-C4 aliphatic hydrocarbon chain,
wherein R₂ and R₃ are individually selected from H or methyl;
wherein n is from about 1800 to about 20,000; and
wherein m is from 4 to 2300.

Also disclosed herein are rubber compositions including the disclosed block copolymers, tires including the rubber compositions, and methods of making the block copolymers.

### BACKGROUND

Hydrophobic rubber compositions routinely include fillers such as, for example, silica and/or carbon black. In many cases, these fillers are hydrophilic, which complicates the process of mixing the fillers into the rubber compositions prior to curing and forming finished objects. Precipitated silica is generally hydrophilic in nature and therefore has a greater affinity to itself, with less affinity to a diene-based elastomer in a rubber composition, which makes it difficult to obtain a satisfactory dispersion of the precipitated silica throughout the rubber composition. To address this, precipitated silica may be mixed with a suitable dispersant. Various strategies to incorporate hydrophilic fillers and to reduce the resultant viscosity in uncured rubber compositions, such as increasing the temperature of mixing steps, can have detrimental effects on the rubbers. It would be desirable to reduce viscosity during mixing of uncured rubbers without resorting to the use of increased temperatures or other harsh means to promote mixing. It would additionally be desirable if the strategy to reduce viscosity during mixing also improved properties of the final rubber compositions and articles, such as tires, made using the same, including lower cured compound hysteresis for improved rolling resistance.

Dispersal is typically performed, for example, by using an increased amount of stearic acid or other wax, which can negatively affect the final properties of articles made from the rubber compositions. Various other dispersants and couplers for incorporating hydrophilic fillers into rubber are known. However, use of these components adds to the cost of producing rubber compositions. Thus, novel lower-cost dispersants are needed. It would be desirable if the dispersants incorporated both hydrophilic moieties for binding to silica or other fillers and hydrophobic moieties for binding to rubber in order to better disperse the filler.

Despite advances in rubber production research, there is still a scarcity of compounds and methods for incorporating polar hydrophilic silica fillers into hydrophobic rubber compositions. Cured rubber made according to the methods and articles made therefrom would have properties such as stiffness and tensile properties comparable to or better than currently used rubber compositions. These needs and other needs are satisfied by the present disclosure.

### SUMMARY

In accordance with the purpose(s) of the present disclosure, as embodied and broadly described herein, the disclosure, in one aspect, relates to a block copolymer comprising a first block derived from an alkene and a second block derived from an epoxide. In another aspect, the block copolymer has the structure

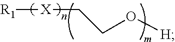

wherein X is selected from:

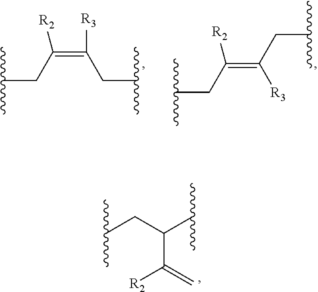

or any combination thereof;
wherein R₁ is selected from H or a C1-C4 aliphatic hydrocarbon chain,
wherein R₂ and R₃ are individually selected from H or methyl;
wherein n is from about 1800 to about 20,000; and
wherein m is from 4 to 2300.

Also disclosed herein are rubber compositions including the disclosed block copolymers, tires including the rubber compositions, and methods of making the block copolymers. In one aspect, the block copolymers can assist with wetting of the surface of a silica filler, or can passivate silica via condensation reactions. In another aspect, the polymer ends can be modified to provide additional functionalities.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows 1H-NMR spectra of exemplary block copolymers having polyethylene oxide blocks of different weights. Peaks labeled with numbers followed by “BD” represent polybutadiene-derived protons, while peaks labeled with numbers followed by “EO” represent ethylene oxide-derived protons.

FIG. 2A shows a 1H NMR spectrum of an exemplary block copolymer showing resonances consistent with polyethylene oxide repeat units at about 3.65 ppm. FIG. 2B shows a DOSY-filtered 1H NMR spectrum showing polyethylene oxide signals, showing formation of a BD-EO block copolymer. FIG. 2C shows a DOSY plot. Tailing of polyethylene oxide signals indicates the presence of an EO homopolymer and a BD-EO block copolymer in the sample.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.”

As used in the specification and the appended claims, the singular forms “a,” “an” and “the” include plural referents unless the context clearly dictates otherwise. Thus, for example, reference to “a filler,” “a block copolymer,” or “an alkene,” include, but are not limited to, mixtures or combinations of two or more such fillers, block copolymers, or alkenes, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

Unless otherwise specified, pressures referred to herein are based on atmospheric pressure (i.e. one atmosphere).

### Block Copolymers and Methods for Making the Same

In one aspect, the block copolymers disclosed herein include a first block derived from an alkene and a second block derived from an epoxide. In some aspects, the alkene can be styrene, butadiene, isoprene, or any combination thereof, and can have a molecular weight of from about 2 kDa to about 1,000,000 kDa, or from about 5 kDa to about 500,000 kDa, or from about 5 kDa to about 50,000 kDa, or from about 5 kDa to about 1000 kDa, or from about 5 kDa to about 100 kDa. In some aspects, the epoxide can be an unsubstituted epoxide, leading to the formation of ethylene oxide units in the second block, or can be a substituted epoxide, leading to the formation of second blocks including polypropylene oxide, polybutylene oxide, and others. In an aspect, the block copolymer can include from about 0.5 to about 10 wt % of the second block, from about 1 to about 8 wt % of the second block, or from about 1 to about 5 wt % of the second block. In some aspects, the second block has a molecular weight of from about 0.2 kDa to about 100 kDa, or from about 0.5 kDa to about 100 kDa, or from about 0.2 kDa to about 2 kDa.

In another aspect, the block copolymer can have the structure

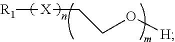

wherein X is selected from:

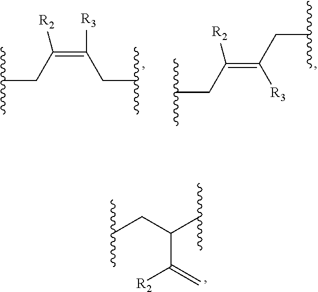

or any combination thereof;
wherein R₁ is selected from H or a C1-C4 aliphatic hydrocarbon chain,
wherein R₂ and R₃ are individually selected from H or methyl;
wherein n is from about 1800 to about 20,000; and
wherein m is from 4 to 2300.

Further in this aspect, all units of X can be the same or X can include a mixture or combination of different addition products.

In one aspect, the block copolymers described herein can be produced by a method including at least the following steps:
(a) polymerizing an alkene to produce a polymerized alkene; and
(b) polymerizing an epoxide in the presence of the polymerized alkene to produce the block copolymer.

In a further aspect, polymerization can be anionic polymerization and can include mixing the alkene with an initiator (e.g., an anionic initiator) and a multidentate ligand in a first solvent. In any of these aspects, the alkene can be selected from butadiene, isoprene, styrene, or any combination thereof, and can produce a rubber when polymerized. In another aspect, the initiator can be n-butyllithium, s-butyllithium, t-butyllithium, or any combination thereof. In a further aspect, the multidentate ligand can be tetramethylethylenediamine (TMEDA), ditetrahydrofurylpropane (DTP), or any combination thereof. In a further aspect, the first solvent can be a nonpolar aprotic solvent such as, for example, cyclohexane, hexane, or any combination thereof. In some aspects, the polymerized alkene in a first solvent is mixed with the epoxide in a second solvent to form a first admixture.

In one aspect, the epoxide can be a substituted or unsubstituted epoxide. In another aspect, step (b) can be conducted in the presence of an organoaluminum compound. In a further aspect, the second solvent can be a polar aprotic solvent such as, for example, diethyl ether, methyl tert-butyl ether (MTBE), tetrahydrofuran (THF), or any combination thereof. In some aspects, an organoaluminum compound, such as, for example, triisobutylaluminum, can be added to the first admixture. In an aspect, the organoaluminum compound can be added after from about 10 min to about 24 h, or after about 10, 15, 20, 25, 30, 35, 40, 45, 50, or 55 min, or about 1, 2, 3, 4, 5, 6, 7, 8, 9, 10, 12, 14, 16, 18, 20, 22, or about 24 h. In one aspect, step (b) can be conducted at from about 0° C. to about 65° C., or at about 0, 5, 10, 15, 20, 25, 30, 35, 40, 45, 50, 55, 60, or about 65° C. In any of these aspects, step (b) can be carried out for from about 4 h to about 2 days, or for about 4, 6, 8, 10, 12, 16, 20, 24, 28, 32, 36, 40, 44, or about 48 h.

In any of these aspects, the block copolymer can precipitated from a third solvent (e.g. acetone, isopropyl alcohol, or a combination thereof), pan dried, drum dried, or stripped to recover the block copolymer.

In one aspect, the block copolymers can assist with wetting of the surface of a silica filler, or can passivate silica via condensation reactions. In another aspect, the polymer ends can be modified to provide additional functionalities. In one aspect, a modified silica includes silica particles and a block copolymer as described herein. In one aspect, the block copolymer is covalently bonded to the silica particles. In one aspect, the terminal hydroxyl group of the block copolymer can react with functional groups (e.g., hydroxyl groups) on the surface of the silica particles under appropriate conditions so that the block copolymer forms a covalent bond with the silica particles. Any of the untreated silica particles described herein can be used to produce the modified silica.

### Rubber Compositions and Applications Thereof

The block copolymers described herein can be used to produce rubber compositions or incorporated into rubber compositions. In some aspects, the disclosed rubber compositions include a solution polymerized styrene-butadiene rubber (SBR). In one aspect, the solution polymerization prepared SBR (sSBR) can have a bound styrene content in the range of from about 5 percent to about 50 percent, or from about 9 percent to about 26 percent. In a further aspect, the sSBR can be conveniently prepared by organolithium catalysis in the presence of a hydrocarbon solvent.

In one aspect, a reference to glass transition temperature, or T_{g}, of an elastomer or elastomer composition, when used herein, represents the glass transition temperature(s) of the respective elastomer or elastomer composition in its uncured state or, in the case of an elastomer composition, in some aspects, T_{g} can be measured in a cured state. In an aspect, T_{g} can be suitably determined as a peak midpoint by a differential scanning calorimeter (DSC) using a test standard such as, for example, ASTM D7426 or equivalent.

In one embodiment, the solution polymerized styrene-butadiene rubber has a glass transition temperature in a range of from about −85° C. to about 0° C., or from about −85° C. to about −50° C., or from about −40° C. to about 0° C. In a further aspect, the styrene butadiene rubber can include a blend of two or more styrene-butadiene rubber having different T_{g}. In a further aspect, such a blend of styrene-butadiene rubbers can include functionalized SBRs, non-functionalized SBRs, or a combination of functionalized and non-functionalized styrene-butadiene rubbers.

In an aspect, commonly employed silicas that can be used in the disclosed rubber compositions include conventional pyrogenic and precipitated silica. In a further aspect, the precipitated silicas can be, for example, those obtained by the acidification of a soluble silicate, e.g., sodium silicate. In a further aspect, such conventional silicas can be characterized, for example, by having a BET surface area, as measured using nitrogen gas. In one embodiment, the BET surface area can be in the range of from about 150 square meters per gram to about 200 square meters per gram. In another embodiment, the BET surface area can be in a range of from about 160 square meters per gram to about 170 square meters per gram. In another aspect, the conventional silica can also be characterized by having a dibutylphthalate (DBP) absorption value in a range of from about 100 to about 400, alternatively from about 150 to about 300. In still another aspect, the conventional silica might be expected to have an average ultimate particle size, for example, in the range of from about 0.01 micron to 0.05 micron as determined by electron microscope, although other sizes are also contemplated and should be considered disclosed.

In one aspect, an untreated silica is useful herein. In a further aspect, the untreated silica can be a prewashed, wet filter cake of precipitated silica having hydroxyl groups thereon. In a further aspect, the precipitated silica can be derived from rice husk ash or bagasse (sugar cane) ash or the like and need not be dried following washing and filtration of an acid-treated sodium silicate.

In some aspects, the untreated silica is diluted in water (or other aqueous medium that is predominantly water) to form an aqueous slurry. In one embodiment, the slurry can contain from 5-30 wt % silica, or at least 10 wt % silica, or another suitable dilution that is able to be pumped through a spray dryer. In any of these aspects, the pH of the slurry can be adjusted, e.g., to a pH of from about 6 to about 7.

In one aspect, a silica gel can be derived, for example, by hydrophobating a silica hydrogel with, for example, an organomercaptosilane and alkyl silane and drying the product.

In some aspects, the temperature of the slurry is raised to (or maintained at) a temperature at which the coupling agent reacts with the hydrated surface of the silica, but which is below the boiling point of water, e.g., at least 20° C., or at least 40° C., or at least 60° C., or up to 90° C., or up to 95° C., such as between about 80 and about 85° C. In a further aspect, the silica coupling agent is allowed to react with the silica for a time which is sufficient to allow completion of the reaction.

In some aspects, the slurry is then dried, e.g., by spray drying, at a temperature above the boiling point of water, such as at least 130° C. or at least 150° C. In one aspect, the dried product can be in the form of substantially spherical beads, granules, or a powder (all of which are generally referred to herein as particles).

In some aspects, an organosilane coupling agent is incorporated into the disclosed compositions. In one aspect, the organosilane coupling agent used can include a first reactive moiety which includes a silicon atom and at least one hydrolyzable group, and a second reactive moiety capable of reaction with a double bond of a vulcanizable elastomer, the first and second reactive moieties being connected by a bridging unit comprising at least one of a polysulfide and a hydrocarbylene group. Further in this aspect, at least one of the hydrolyzable groups of the first reactive moiety can be selected from an alkoxy group and an aminoalkyl group. In some aspects, the coupling agent can be selected from bis(trialkoxysilylalkyl) polysulfides, bis(alkoxyaryloxysilylalkyl) polysulfides, bis(triaryloxysilylalkyl) polysulfides, and mixtures thereof.

In one aspect, the pretreated silica material can have a CTAB surface area of at least 30 m²/g, or at least 50 m²/g, or at least 100 m²/g, or at least 200 m²/g, or up to 300 m²/g, or up to 400 m²/g, or up to 500 m²/g, as measured according to ASTM D6845-20. In one aspect, the untreated precipitated silica can have a pH of 6-8, resulting from residual sodium sulfate.

In one aspect, the untreated silica can have a particle size of less than 10 micrometers (μm), or less than 5 μm, or at least 0.1 μm, as determined by ASTM C721-20, “Standard Test Methods for Estimating Average Particle Size of Alumina and Silica Powders by Air Permeability.” (Silica primary particles for rubber usage are usually in the 10 to 100 nanometer range, 0.01 to 0.1 micrometers) as measured by Differential Centrifugal Sedimentation (DCS).

Exemplary untreated precipitated silicas are available from PPG Industries as Hi-Sil™, e.g., under the designations 210, 243, 315, EZ 160G-D, EZ 150G, 190G, 200G-D, HDP-320G, and 255CG-D; from Solvay as Zeosil™, under the designations 115GR, 125GR, 165GR, 175GR, 185GR, 195GR, 1085GR, 1165MP, 1115MP, HRS 1200MP, Premium MP, Premium 200MP, and 195 HR; from Evonik as Ultrasil™, under the designations VN2, VN3, VN3GR, 5000GR, 7000GR, 9000GR, as Zeopol™, under the designations 8755LS and 8745; from Wuxi Quechen Silicon Chemical Co., Ltd. as Newsil™, under the designations 115GR and 2000MP; from Maruo Calcium Co., Ltd., as Tokusil™ 315, and silicas derived from rice husk ash from Yihai Food and Oil Industry, China. Any precipitated silica can be used in the method. In other embodiments, the untreated precipitated silica is prepared as a wet filtered material shortly before use.

In one aspect, a silica coated carbon black and/or commonly employed carbon blacks can also be used as filler in an amount ranging from 10 to 150 phr. In another embodiment, from 20 to 80 phr of carbon black can be used. Representative examples of such carbon blacks include N110, N121, N134, N220, N231, N234, N242, N293, N299, N315, N326, N330, N332, N339, N343, N347, N351, N358, N375, N539, N550, N582, N630, N642, N650, N683, N754, N762, N765, N774, N787, N907, N908, N990 and N991. These carbon blacks have iodine absorptions ranging from 9 to 145 g/kg and DBP number ranging from 34 to 150 cm³/100 g.

In another aspect, other fillers can be used in the rubber composition including, but not limited to, particulate fillers including ultra-high molecular weight polyethylene (UHMWPE), crosslinked particulate polymer gels and plasticized starch composite filler. In a further aspect, such other fillers can be used in an amount ranging from 1 phr to 30 phr.

In another aspect, the rubber composition can optionally include rubber processing oil. Further in this aspect, the rubber composition can include from 0 to about 100 phr of processing oil. In a still further aspect, processing oil can be included in the rubber composition as extending oil typically used to extend elastomers. In another aspect, processing oil can also be included in the rubber composition by addition of the oil directly during rubber compounding. In yet another aspect, the processing oil used can include both extending oil present in the uncured rubber prior to processing, and process oil added during compounding. In one embodiment, the rubber composition includes a low PCA oil. Suitable low PCA oils include, but are not limited to, mild extraction solvates (MES), treated distillate aromatic extracts (TDAE), residual aromatic extract (RAE), SRAE, and heavy naphthenic oils as are known in the art. In a further aspect, suitable low PCA oils include those having a polycyclic aromatic content of less than 3 percent by weight as determined by the IP 346 method. Procedures for the IP 346 method can be found in Standard Methods for Analysis and Testing of Petroleum and Related Products and British Standard 2000 Parts, 2003, 62nd edition, published by the Institute of Petroleum, United Kingdom.

In an aspect, suitable TDAE oils are available as Tudalen® SX500 from Klaus Dahleke K G, VivaTec® 400 and VivaTec® 500 from H&R Group, Enerthene@ 1849 from BP, and Extensoil® 1996 from Repsol. In a further aspect, the oils may be available as the oil alone or can be provided along with an elastomer in the form of an extended elastomer. In another aspect, suitable vegetable oils include, but are not limited to, soybean oil, sunflower oil, and canola oil, which can be provided in the form of esters containing a certain degree of unsaturation.

In one aspect, a rubber composition including the disclosed block copolymers could be compounded by methods generally known in the rubber compounding art, such as mixing various sulfur-vulcanizable constituent rubbers with variously commonly used additive materials such as, for example, curing aids, such as sulfur activators, retarders and accelerators, processing additives such as oils, resins including tackifying, traction, and thermoplastic resins and plasticizers, fillers, pigments, fatty acid, zinc acid, waxes, antioxidants and antiozonants (anti-degradants), peptizing agents, and reinforcing materials. In an aspect, depending on the intended use of the sulfur vulcanizable and sulfur vulcanized material (rubbers), the additives mentioned above are selected and commonly used in conventional amounts.

Representative examples of sulfur donors include elemental sulfur (free sulfur), an amine disulfide, polymeric polysulfide, and sulfur olefin adducts. In one aspect, the sulfur-vulcanizing agent is elemental sulfur. In another aspect, the sulfur-vulcanizing agent can be used in an amount ranging from about 0.5 phr to about 8 phr, or from about 1.5 phr to about 6 phr. Typical amounts of resins can be added in a range of from about 0 phr to about 100 phr. Typical amounts of processing aids can be added in an amount of from about 1 phr to about 50 phr. Typical amounts of antioxidants can be from about 1 phr to about 5 phr. In an aspect, representative antioxidants include, but are not limited to, diphenyl-p-phenylenediamine. Typical amounts of antiozonants can be from about 1 phr to about 5 phr. Typical amounts of fatty acids can include stearic acid and can be present in an amount of from about 0.5 phr to about 3 phr.

In one aspect, typical amounts of zinc oxide can be from about 2 phr to about 5 phr. Typical amounts of waxes can be from about 1 phr to about 5 phr. In an aspect, microcrystalline waxes can be used. Typical amounts of peptizers can be from about 0.1 phr to about 1 phr. In one aspect, a typical peptizer can be, for example, dibenzamidodiphenyl disulfide.

In one aspect, accelerators can be used to control the time and/or temperature required for vulcanization and to improve the properties of the vulcanizate. In one embodiment, a single accelerator system can be used, i.e., a primary accelerator. In another embodiment, the primary accelerator(s) can be used in total amounts ranging from about 0.5 phr to about 4 phr, or from about 0.8 phr to about 1.5, phr. In another embodiment, combinations of a primary and a secondary accelerator can be used, with the secondary accelerator being used in smaller amounts, such as from about 0.05 phr to about 3 phr, in order to activate and to improve the properties of the vulcanizate. In an aspect, combinations of these accelerators might be expected to produce a synergistic effect on the final properties of the cured rubber and may be somewhat better than those produced by use of either accelerator alone. In an additional aspect, delayed action accelerators can be used; these are not affected by normal processing temperatures but produce a satisfactory cure at ordinary vulcanization temperatures. In some aspects, vulcanization retarders can also be used. Suitable types of accelerators that can be used in the present invention are amines, disulfides, guanidines, thioureas, thiazoles, thiurams, sulfonamides, dithiocarbamates, and xanthates. In one embodiment, the primary accelerator is a sulfonamide. If a second accelerator is used, the secondary accelerator can be a guanidine, dithiocarbamate, or thiuram compound. In another aspect, other curatives can be used, including, but not limited to, from about 0.5 phr to about 5 phr of 1,6-bis(N,N′ dibenzylthio-carbamoyldithio)-hexane, which is available as Vulcuren from Lanxess.

In one aspect, the cured rubber compound that includes the block copolymers disclosed herein can be incorporated in a variety of rubber articles, including, for example, tire components, rubber belts, and hoses, among others. In one aspect, the tire component can be a tire tread such including at least one of tread cap and/or tread base rubber layer tire sidewall, tire carcass component, such as, for example, a carcass cord ply coat, tire sidewall stiffening insert, an apex adjacent to or spaced apart from a tire bead, wire coat, inner liner tire chafer and/or tire bead component. In a further aspect, the tread and/or tires can be built, shaped, molded and cured by various methods which will be readily apparent to those skilled in the art.

In one aspect, a pneumatic tire as disclosed herein can be a race tire, passenger tire, aircraft tire, agricultural, earth-mover, off-the-road, truck tire, or the like. In one embodiment, the tire is a passenger or truck tire. In another embodiment, the tire can also be a radial or bias. In one embodiment, the tire component is intended to be ground-contacting. In another embodiment, the tire component is not ground contacting. In other embodiments, the rubber compound can be incorporated in a non-pneumatic tire.

In yet another aspect, the mixing of the rubber composition can be accomplished by methods known to those having skill in the rubber mixing art. For example, the ingredients are typically mixed in at least two stages, namely, at least one non-productive stage followed by a productive mix stage. Further in this aspect, the final curatives including sulfur-vulcanizing agents are typically mixed in the final stage which is conventionally called the “productive” mix stage in which the mixing typically occurs at a temperature, or ultimate temperature, lower than the mix temperature(s) than the preceding non-productive mix stage(s). The terms “non-productive” and “productive” mix stages are well known to those having skill in the rubber mixing art. In another aspect, the rubber composition can be subjected to a thermomechanical mixing step. Further in this aspect, the thermomechanical mixing step generally includes a mechanical working in a mixer or extruder for a period of time suitable in order to produce a rubber temperature between 140° C. and 190° C. The appropriate duration of the thermomechanical working varies as a function of the operating conditions, and the volume and nature of the components. In one example, the thermomechanical working can be from about 1 minute to about 20 minutes.

In still another aspect, after mixing, the compounded rubber can be fabricated by a method such as, for example, by extrusion through a suitable die to form a tire tread (including tread cap and tread base). In a further aspect, the tire tread is typically built onto a sulfur curable tire carcass and the assembly thereof cured in a suitable mold under conditions of elevated temperature and pressure by methods well-known to those having skill in the art.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### ASPECTS

The present disclosure can be described in accordance with the following numbered aspects, which should not be confused with the claims.

Aspect 1. A block copolymer comprising a first block derived from an alkene and a second block derived from an epoxide.

Aspect 2. The block copolymer of aspect 1, wherein the alkene comprises styrene, butadiene, isoprene, or any combination thereof.

Aspect 3. The block copolymer of aspect 1 or 2, wherein the first block comprises polybutadiene, polyisoprene, or styrene butadiene rubber.

Aspect 4. The block copolymer of any one of aspects 1-3, wherein the first block has a molecular weight of from about 2 kDa to about 1,000,000 kDa.

Aspect 5. The block copolymer of aspect 4, wherein the first block has a molecular weight of from about 5 kDa to about 100 kDa.

Aspect 6. The block copolymer of any one of aspects 1-5, wherein the epoxide comprises a substituted or unsubstituted epoxide.

Aspect 7. The block copolymer of any one of aspects 1-6, wherein the second block comprises polypropylene oxide units or polybutylene oxide units.

Aspect 8. The block copolymer of any one of aspects 1-7, wherein the block copolymer comprises from about 0.5 wt % to about 10 wt % of the second block.

Aspect 9. The block copolymer of aspect 8, wherein the block copolymer comprises from about 1 wt % to about 5 wt % of the second block.

Aspect 10. The block copolymer of any one of aspects 1-9, wherein the second block has a molecular weight of from about 0.2 kDa to about 2 kDa.

Aspect 11. The block copolymer of aspect 10, wherein the second block has a molecular weight of from about 0.5 kDa to about 100 kDa.

Aspect 12. The block copolymer of any one of aspects 1-11, wherein the block copolymer has the structure:

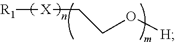

wherein X is selected from:

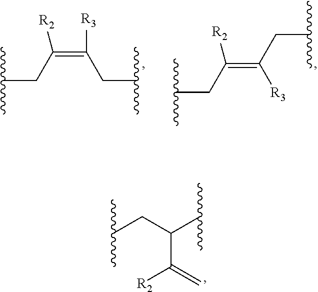

or any combination thereof;
wherein R₁ is selected from H or a C1-C4 aliphatic hydrocarbon chain,
wherein R₂ and R₃ are individually selected from H or methyl;
wherein n is from about 1800 to about 20,000; and
wherein m is from 4 to 2300.

Aspect 13. The block copolymer of aspect 12, wherein all X are the same.

Aspect 14. The block copolymer of aspect 12 or 13, wherein the block copolymer has the structure:

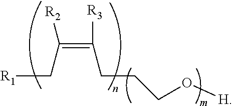

Aspect 15. The block copolymer of any one of aspects 12-14, wherein n is about 460 to about 470.

Aspect 16. The block copolymer of any one of aspects 12-15, wherein m is from about 57 to about 114.

Aspect 17. The block copolymer of any one of aspects 12-16, wherein R₁ is H.

Aspect 18. The block copolymer of any one of aspects 12-17, wherein R₂ and R₃ are H.

Aspect 19. The block copolymer of any one of aspects 1-18, wherein the block copolymer has a glass transition temperature (T_{g}) of from about −90° C. to about −5° C.

Aspect 20. A method for making a block copolymer comprising a first block derived from an alkene and a second block derived from an epoxide, the method comprising:
(a) polymerizing an alkene to produce a polymerized alkene; and
(b) polymerizing an epoxide in the presence of the polymerized alkene to produce the block copolymer.

Aspect 21. The method of aspect 20, wherein the polymerized alkene in step (a) is produced by anionic polymerization of the alkene.

Aspect 22. The method of aspect 20 or 21, wherein polymerizing the alkene in step (a) comprises mixing the alkene with an initiator (e.g., an anionic initiator) and a multidentate ligand in a first solvent.

Aspect 23. The method of any one of aspects 20-22, wherein the alkene comprises butadiene, isoprene, styrene, or any combination thereof.

Aspect 24. The method of aspect 22 or 34, wherein the initiator comprises n-butyllithium, s-butyllithium, t-butyllithium, or any combination thereof.

Aspect 25. The method of any one of aspects 22-24, wherein the multidentate ligand comprises tetramethylethylenediamine (TMEDA), ditetrahydrofurylpropane (DTP), or any combination thereof.

Aspect 26. The method of any one of aspects 22-25, wherein the first solvent comprises a nonpolar aprotic solvent.

Aspect 27. The method of aspect 26, wherein the nonpolar solvent comprises cyclohexane, hexane, or any combination thereof.

Aspect 28. The method of any one of aspects 20-27, wherein step (b) comprises mixing the polymerized alkene in a first solvent with the epoxide in a second solvent to form a first admixture.

Aspect 29. The method of any one of aspects 20-28 wherein the epoxide comprises a substituted or unsubstituted epoxide.

Aspect 30. The method of any one of aspects 20-29, wherein step (b) is conducted in the presence of an organoaluminum compound.

Aspect 31. The method of any one of aspects 28-30, wherein the second solvent comprises a polar aprotic solvent.

Aspect 32. The method of aspect 31, wherein the polar aprotic solvent comprises diethyl ether, methyl tert-butyl ether (MTBE), tetrahydrofuran (THF), or any combination thereof.

Aspect 33. The method of any one of aspects 28-32, further comprising adding an organoaluminum compound to the first admixture.

Aspect 34. The method of aspect 33, wherein the organoaluminum compound comprises triisobutylaluminum.

Aspect 35. The method of aspect any one of aspects 20-34, wherein step (b) is conducted at from about 0° C. to about 65° C.

Aspect 36. The method of any one of aspects 33-35, wherein the organoaluminum compound is added after from about 10 min to about 24 h.

Aspect 37. The method of any one of aspects 20-36, wherein step (b) is carried out for from about 4 h to about 2 days.

Aspect 38. The method of any one of aspects 20-37, wherein the block copolymer is precipitated from a third solvent, pan dried, drum dried, or stripped to recover the block copolymer.

Aspect 39. The method of aspect 38, wherein the third solvent comprises acetone, isopropyl alcohol, or any combination thereof.

Aspect 40. A block copolymer produced by the process of any one of aspects 20-39.

Aspect 41. A rubber composition comprising the block copolymer of any one of aspects 1-19 or 40 and at least one filler.

Aspect 42. The rubber composition of aspect 41, wherein the at least one filler comprises silica, carbon black, or any combination thereof.

Aspect 43. A tire comprising the rubber composition of aspect 41 or 42.

Aspect 44. A modified silica composition comprising a silica particles and the block copolymer of any one of aspects 1-19 and 40.

Aspect 45. The modified silica composition of aspect 44, wherein the block copolymer is covalently bonded to the silica particles.

### Examples

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Synthesis of Block Copolymers

Butadiene polymerization was initiated using 0.127 M BuLi in hexane and 1 equivalent of TMEDA and polymerized to achieve 25 kDa molecular weight at ambient temperature in a nonpolar solvent such as cyclohexane or hexane. In some experiments, the BuLi was n-butyllithium, s-butyllithium, and/or t-butyllithium. In some experiments, other multidentate ligands such as ditetrahydrofurylpropane (DTP) were used. After formation of the first block, a THF solution of ethylene oxide (2.5-3.3 M, provided by Sigma Aldrich) was added to the polymerization solution. In some experiments, diethyl ether or methyl tert-butyl ether (MTBE) was used as the solvent. Disappearance of the orange color was observed immediately. The mixture was heated to 40° C. for 24 h and 6 equivalents of 25 wt % triisobutylaluminum (TIBA) or another organoaluminum compound in hexane were added, although temperatures from 0° C. to 65° C. were also acceptable. The solution became cloudy within 10 min. The reaction was allowed to continue for 2 additional days. The reaction mixture was successfully precipitated from both diethyl ether (providing an off-white flaky powder) or isopropanol (providing a gel). Pan drying, drum drying, and stripping also resulted in recovery. Scheme 1 shows an exemplary reaction, with n=463 and m=57 or 114:

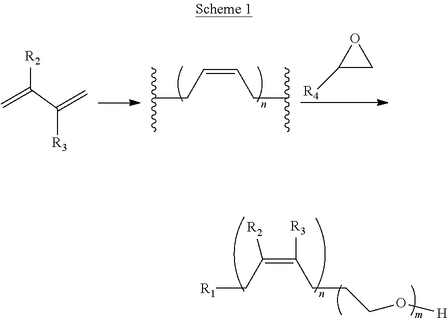

### Example 2: Characterization of Block Copolymers

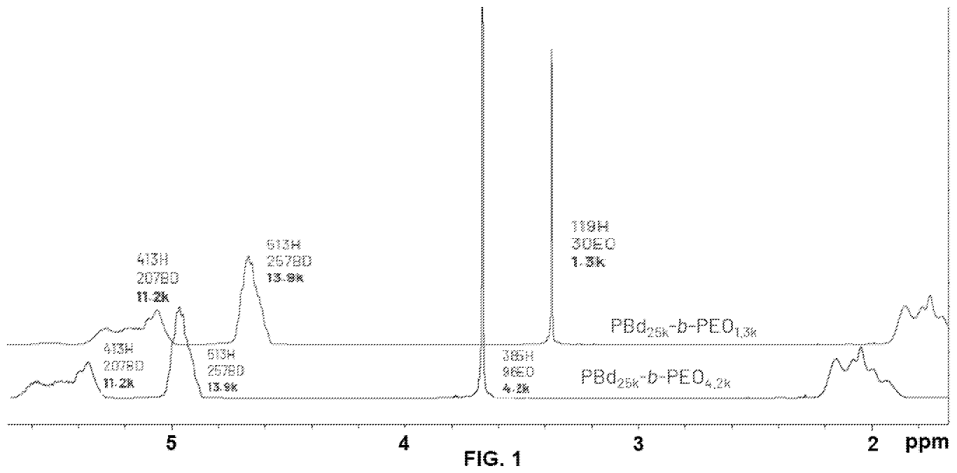

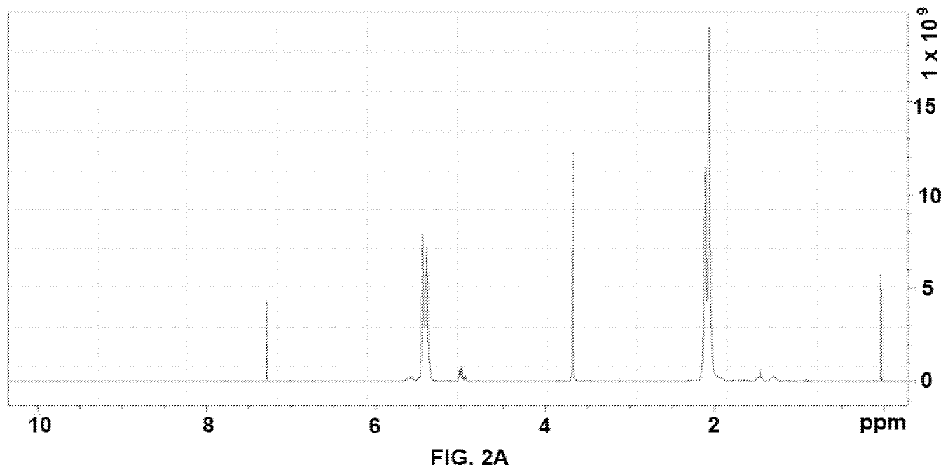

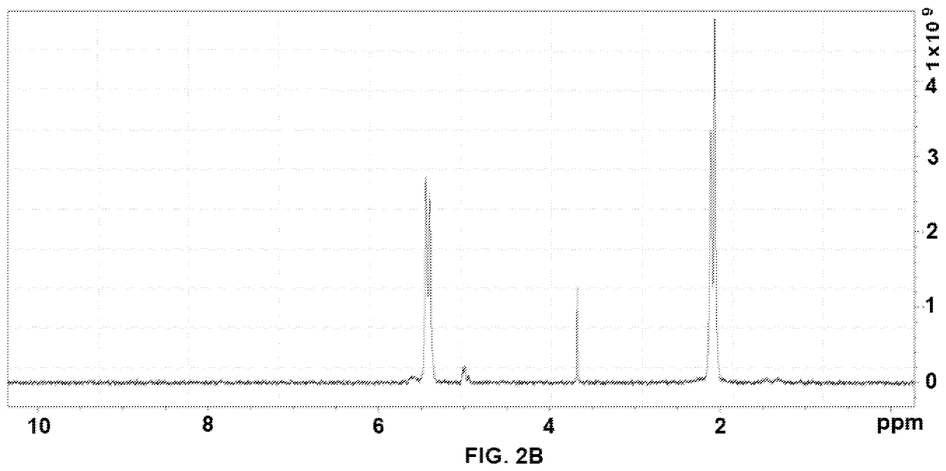

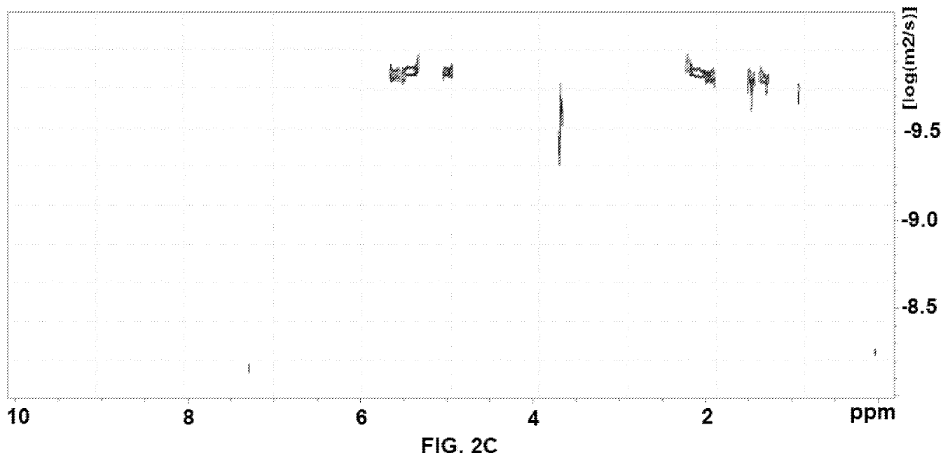

Two targeted polymers were prepared, a first with a 25 kDa polybutadiene (55% vinyl) block coupled with a 2.5 kDa polyethylene oxide block, and a second with a 25 kDa polybutadiene (55% vinyl) block coupled with 5 kDa polyethylene oxide block. For the first, 8 mL of 2.5-3.3 M ethylene oxide in THF were used in the procedure described in Example 1, and for the second, 16 mL of 2.5-3.3 M ethylene oxide in THF were used in the procedure described in Example 1. 28-37% and 46-60% chain extension were observed by NMR (FIG. 1). Two dimensional DOSY experiments were performed to confirm the formation of block copolymers (FIGS. 2A-2C).

Differential scanning calorimetry (DSC) was performed on polymers with 0.15 equivalents ethylene oxide and 0.3 equivalents ethylene oxide, revealing a glass transition temperature (T_{g}) at around −30° C. and no melting between −100° C. and 60° C., which is different from polyethylene oxide (showing a clear melting point at about 60° C.).

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

What is claimed is:

1. A block copolymer comprising a first block derived from an alkene and a second block derived from an epoxide.

2. The block copolymer of claim 1, wherein the alkene comprises styrene, butadiene, isoprene, or any combination thereof.

3. The block copolymer of claim 1, wherein the second block comprises polypropylene oxide units or polybutylene oxide units.

4. The block copolymer of claim 1, wherein the block copolymer has the structure: 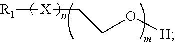
wherein X is selected from: 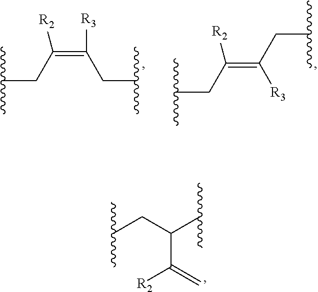
or any combination thereof;
wherein R₁ is selected from H or a C1-C4 aliphatic hydrocarbon chain,
wherein R₂ and R₃ are individually selected from H or methyl;
wherein n is from about 1800 to about 20,000; and
wherein m is from 4 to 2300.

5. A rubber composition comprising the block copolymer of claim 1 and at least one filler.

6. A tire comprising the rubber composition of claim 5.

7. A method for making a block copolymer comprising a first block derived from an alkene and a second block derived from an epoxide, the method comprising:
(a) polymerizing an alkene to produce a polymerized alkene; and
(b) polymerizing an epoxide in the presence of the polymerized alkene to produce the block copolymer.

8. The method of claim 7, wherein polymerizing the alkene in step (a) comprises mixing the alkene with an initiator and a multidentate ligand in a first solvent.

9. The method of claim 8, wherein the initiator comprises n-butyllithium, s-butyllithium, t-butyllithium, or any combination thereof.

10. The method of any one of claim 8, wherein the multidentate ligand comprises tetramethylethylenediamine (TMEDA), ditetrahydrofurylpropane (DTP), or any combination thereof.

11. The method of claim 7, wherein the alkene comprises butadiene, isoprene, styrene, or any combination thereof.

12. The method of claim 7, further comprising adding an organoaluminum compound during step (b).

13. The method of claim 12, wherein the organoaluminum compound comprises triisobutylaluminum.

14. The method of claim 7, wherein the block copolymer is precipitated from a third solvent, pan dried, drum dried, or stripped to recover the block copolymer.

15. The block copolymer of claim 1, wherein the first block comprises polybutadiene, polyisoprene, or styrene butadiene rubber.

16. The block copolymer of claim 1, wherein the block copolymer has a glass transition temperature (T_{g}) of from about −90° C. to about −5° C.

17. The block copolymer of claim 1, wherein the first block has a molecular weight of from about 2 kDa to about 1,000,000 kDa.

18. The block copolymer of claim 1, wherein the block copolymer comprises from about 0.5 wt % to about 10 wt % of the second block.

19. The block copolymer of claim 1, wherein the second block has a molecular weight of from about 0.2 kDa to about 2 kDa.

20. The rubber composition of claim 5, wherein the at least one filler comprises silica, carbon black, or any combination thereof.
